(19) United States
(12) Patent Application Publication
(10) Pub. No.: US 2010/0030799 A1
(43) Pub. Date: Feb. 4, 2010

(54) Method for Generating a Computer-Processed Financial Tradable Index

(76) Inventors: Daniel J. Parker, Chatham, NJ (US); Erik Rothenberg, Playa del Rey, CA (US)

Correspondence Address: WILLIAMSON INTELLECTUAL PROPERTY LAW, LLC, 1870 THE EXCHANGE, SUITE 100, ATLANTA, GA, 30339, US

(21) Appl. No.: 12/182,561

(22) Filed: Jul. 30, 2008

(51) Int. Cl. G06F 17/30

(52) U.S. Cl. 707/102; 707/E17.044

(57) ABSTRACT

A method for generating a computer-processed financial tradable index comprising the steps of gathering organizational data, gathering sentiment data, combining the organizational data and the sentiment data and computing a financial tradable index. More specifically, the organizational data is accessed from public data, entity data and third party data and is representative of environmental, regulatory, economic, technical, social, legal, financial, political and/or policy information. The sentiment data is obtained from an online community and group data comprising perception polls, surveys, questionnaires, pick lists, votes, opinion polls and/or individual opinions. The organizational data and the sentiment data are then multiplied by weighting factors and aggregated into a financial tradable index. Within the computer system Words and/or phrases can be numerically valued, combined, aggregated to construct index valuations.

### CROSS-REFERENCE TO RELATED APPLICATIONS

None

### FEDERALLY SPONSORED RESEARCH OR DEVELOPMENT

None

### PARTIES TO A JOINT RESEARCH AGREEMENT

None

### REFERENCE TO A SEQUENCE LISTING

None

### BACKGROUND OF THE INVENTION

1. Technical Field of the Invention

The present invention relates generally to a method for generating a computer-processed financial tradable index, and more specifically to a method that comprises the steps of gathering organizational data, gathering sentiment data, combining the sentiment data with the organizational data and computing a financial tradable index.

2. Description of Related Art

Healthy, productive, and valued environments, social systems and economies are the basis of sustainable development and human welfare because the natural environment is the primary source of raw materials and absorbs pollution from human activities. During human activity, the environment converts its resources and natural services into those that directly support mankind. As such, the environment is connected to the social and economic experience as represented by human's consumption and contribution thereto.

Unfortunately, extraction of the Earth's natural resources is usually not replaced to an initial baseline, nor is it replenished with the increase in both human consumption and population. Thus, the Earth's natural systems are damaged, overloaded and/or prevented from meeting human needs. Damage or overload of the Earth's resources, if not replenished, replaced or properly valued, may lead to famine, extinction, economic instability, shortages, illness and extreme crisis for the human experience. Our own choices, and more specifically, the way we choose to value natural resources, are directly related to our future human experience. To a large extent we, as humans, determine our own quality of life and the condition of our lands and opportunities for future generations.

Because the Earth's resources are the basis of sustainable development and human welfare, it is necessary to preserve and value the Earth's resources. If pollution is rampant, we may experience a health crisis, which has a cost. From a local perspective, if we do not regulate our carbon emissions, then we may lose competitive value in technology and services against other nations. From a global perspective, if we put others in jeopardy by potentially contributing to climate change, then we must suffer the consequences thereof. If we do not protect natural habitats for wild animals, then we rob our children and ourselves of priceless experiences communing with nature and learning about other species with which we share this world. Extinction of certain species can lead to a health crisis and deplete the availability of plants needed for medical purposes. This loss depletes our spiritual satisfaction and happiness, which has an impact on our economic productivity, and hence a cost. As such, there is a need to implement a valuation system that is comprehensive and has the ability to value and measure activities that impact our human experience, such as, damage done to the environment.

Currently, there are several methods available to evaluate particular entities. For example, financial indexes, such as, the Dow Jones Industrial Average indexes 30 “blue chip” United States stocks of industrial companies. Similarly, the S&P 500 Composite Stock Price Index, indexes 500 stocks from major industries of the United States economy. Additionally, an exchange-traded fund is an investment vehicle traded on stock exchanges and combines the valuation feature of a mutual fund or unit of investment trust, which can be purchased or redeemed at the end of each trading day for its net asset value.

Financial indexes provide many benefits, such as, providing transparency and offering common reference points for the purpose of trading. While financial indexes are useful, the data utilized in creating such indexes are either exclusive to, or bias-based toward financial input data. As such, these existing financial models and indexes do not adequately factor demand for risky assets into their calculations and ultimately limit the potential on returns on investments in a portfolio. Further, traditional financial indexes fail to take into account a variety of non-financial factors in valuing an entity, such as, political, environmental, social, technological, economic and legal data.

Additionally, there are a multitude of online social networks, such as, FACEBOOK and MYSPACE, which allow computer users to post content from their personal computers. In this regard, collective intelligence and predictive markets are subsets of social networking configurations and provide individual users an opportunity to participate in surveys. Such networks allow online voting in “decision rooms,” wherein personal computers connect in either a small, separate computer system or in a network, and wherein users are guided by a facilitator in reaching a group consensus decision. While such social networks are helpful in obtaining information, they fail to operate in a collaborative environment. Accordingly, there is a need for such online data to be accumulated, processed and indexed, wherein numerical values are associated with words or phrases for the purpose of index creation or valuation.

Further, there are a variety of sustainable reporting mechanisms whose primary objectives include international policy making regarding reporting standards. For example, The Greenhouse Gas (GHG) Protocol is an international accounting tool for government and business leaders to understand, quantify, and manage greenhouse gas emissions. The GHG Protocol, a partnership between the World Resources Institute and the World Business Council for Sustainable Development, is working with businesses, governments, and environmental groups around the world to build a new generation of credible and effective programs for tackling climate change. It provides the accounting framework for nearly every GHG standard and program in the world, from the International Standards Organization to The Climate Registry, as well as hundreds of GHG inventories prepared by individual companies.

Similarly, the Environmental Vulnerability Index (EVI) has been developed to focus environmental management. This index is the basis of all human welfare, has been developed by the South Pacific Applied Geoscience Commission (SOPAC), the United Nations Environment Programme (UNEP) and their partners. This index is designed to be utilized with economic and social vulnerability indices to provide insights into the processes that can negatively influence the sustainable development of countries. While sustainability reporting, such as the GHG Protocol and the EVI, promotes transparency and accountability, the reports themselves are not designed to effectively measure, provide comparisons, or determine benchmarks, nor can they be used in current form within the financial markets as a tradable instrument.

Further, there currently exists the concept of data mining and data tagging. Data mining is the process of sorting through large amounts of data and picking out relevant information. It is utilized by organizations to extract information from disparate data-sets. Online Analytical Processing (OLAP) is an approach to quickly provide answers to analytical queries that are multi-dimensional in nature. OLAP is part of the broader category business intelligence, which also encompasses relational reporting and data mining. The typical applications of OLAP are in business reporting for sales, marketing, management reporting, business process management (BPM), budgeting and forecasting, financial reporting, records and similar areas. While data mining has been utilized for business intelligence, it has not been integrated to convert tagged data into a numerical valuation for the purpose of aggregating such into an index value.

Lastly, there currently exist consumer confidence indexes. The University of Michigan Consumer Sentiment Index is a consumer confidence index published monthly by the University of Michigan. The index is normalized to have a value of 100 in December of 1964. The consumer confidence measures were devised in the late 1940's by George Katona at the University of Michigan. There have now developed into an ongoing nationally representative survey based on telephonic household interviews. The Index of Consumer Sentiment (ICS) is developed from these interviews. It gives a very accurate indication of the future course of the national economy. While the Index of Consumer Expectations is included in the Leading Indicator Composite Index published by the U.S. Department of Commerce, Bureau of Economic Analysis, it has not been integrated into a global index.

Further, there are a variety of prediction markets. Prediction markets are speculative markets created for the purpose of making predictions. Assets are created whose final cash value is tied to a particular event (e.g., will the next US president be a Democrat) or parameter (e.g., total sales next quarter). The current market prices can then be interpreted as predictions of the probability of the event or the expected value of the parameter. Prediction markets are thus structured as betting exchanges, whereby the payout is event or data driven. One of the oldest and most famous is the University of Iowa's Iowa Electronic Market. The Hollywood Stock Exchange, a virtual market game established in 1996 and now a division of Cantor Fitzgerald, LP, in which players buy and sell prediction shares of movies, actors, directors, and film-related options, correctly predicted 32 of 2006's 39 big-category Oscar nominees and seven out of eight top category winners. Hedgestreet, designated in 2004 as a market and regulated by the Commodity Futures Trading Commission (CFTC), enables internet traders to speculate on economic events.

Therefore, it is readily apparent that there is a need for a method of providing a more collaborative view of the human social experience by combining organizational data inputs and sentiment data, input to best practices and beyond mere financial indexing to achieve an index comprising variables having a theoretical framework developed to provide the basis for a composite indicator.

### BRIEF SUMMARY OF THE INVENTION

Briefly described, in a preferred embodiment, the present invention overcomes the above-mentioned disadvantages and meets the recognized need for such an apparatus by providing a method for generating a computer-processed financial tradable index. The computer-processed financial tradable index is utilized as an indicator, an index and/or as a basis for currency.

As an indicator, the financial tradable index is a measurement of the value of the natural Earth in its current, worsened or improved state. The indicator is also utilized as a measurement of the value of human potential in its current, worsened or improved state of humanity. The indicator may also be utilized as a measurement of the contribution of an entity, for instance, a corporation, to the value of the natural Earth or human potential and/or an absolute measurement of the value of the natural Earth or human potential and/or a measurement of the relative contribution of an entity to the value of the natural Earth or human potential. Lastly, the indicator is utilized as a measurement comprising PESTLE components (political, economic, social, technological, legal, environmental), including both organizational and sentiment data measurements into a unified single number.

As an index, the method for computing a financial tradable index is utilized as a unified table comprising PESTLE components (political, economic, social, technological, legal and environmental). The index may be utilized as an underlyer comprising the basis of value of the natural Earth and/or human potential and/or an underlyer based on measurements of a baseline target or variance and/or an underlyer comprising financial products.

In one embodiment, the index measures a common way of comparing different units of analysis. The value being a common comparison to serve as a valid economic springboard for incentives to move toward equilibrium of the three factors of social/economic/environmental.

In another embodiment, the index serves as a potential, transparent view relative to a time goal, relative or absolute goal, or outright comparison. The weighting, harmonization and aggregation includes a fair process such as, for exemplary purposes only, voting, to close down uncertainty, and as a means of exercising the wisdom of crowds.

Lastly, the index is utilized as a source of multiple indexes identifying the performance of individual PESTLE indicators (or combinations thereof) in meaningful combinations to serve three objectives: climate balance, restoring Earth and uplifting humanity, or as an indicator of performance of a given community sector to serve these three objectives.

As a basis for a currency, the financial tradable index is utilized as an underlyer of the value the currency represents and/or as an underlyer of the value for multiple currencies that represents the service to the aforementioned three objectives according to a selected unit of analysis/measurement: i.e., a geographic region, an industry sector, a government, a corporation and/or ad-hoc community groups.

Further, the financial tradable index comprises composite indicators, such as, for exemplary purposes only, consistent indicators, comparable indicators, interrelationships, interactions, relative importance to policies concerned, Summary of underlying individual indicators or variables, relative position in given area, time, and direction of change.

Lastly, in developing a theoretical framework for the index, one embodiment ties the indicators to political, social, environmental, economic, financial, technology, regulatory, and/or legal variables, wherein the relevant variables are based on a paradigm concerning the behavior being analyzed.

According to its major aspects and broadly stated, the present invention is a method for generating a computer-processed financial tradable index comprising the steps of gathering organizational data, gathering sentiment data, combining the sentiment data with the organizational data and computing a financial tradable index.

The organizational data is objective and based on a plurality of measurement and weighting conventions. It may be descriptive of water usage, carbon output, use of toxins, energy diversification, sponsored social or community outreach, level of contribution or charitable giving, certain policy positions regarding the environment, ability of organization to achieve stated goals relative to conservation, process improvement, resource allocation, policy action and/or the like. The organizational data is characterized by positive and negative numerical changes and is obtained from municipalities, governments, for-profit entities, non-profit entities, organizations that operate in a plurality of geographic locations, organizations that operate in a plurality of industries, public databases, entity (e.g., corporation) public databases, third-party databases, independent parties, public domain sources, indexes and/or data representing indexes. The organizational data relates to and comprises data inputs such as, for exemplary purposes only, financial, legal, environmental, economic, political, social, regulatory, policy and/or technological information.

The sentiment data is subjective and based on a plurality of measurement and weighting conventions, such as, for exemplary purposes only, policy and action (or proposed action) regarding energy, resource consumption, air, water, land, climate change, biodiversity agricultural use, metals, commodities, ecosystems waste, toxins, recycling, social contribution and/or the like. The sentiment data is gathered from users in an on-line community, such as, for exemplary purposes only, from technology networks and Internet websites. Additionally, sentiment data is gathered via a communications network having a terminal, an input device and a server. The server has a database with storage fields, an input data object generator, an output data object generator and a choice generator, wherein the choice generator comprises a pick list of options/answers that a user community could choose from (like a multiple choice test). This provides the community an opportunity to vote with regard to specific choices presented to them. The sentiment data relates to consensus data, responses to surveys, questionnaires, on-line pick lists, votes, opinion polls, perception poll and/or individual opinions.

The organizational data and the sentiment data are directly delivered and aggregated into a computer server. A weighting method is applied to the organizational data (and optionally to the sentiment data), thereby forming weighted organizational data (and/or weighted sentiment data). An index is formed from the weighted organizational data. The organizational data is multiplied by weighting factors that are quantified, thereby creating a baseline variance. The weighting factors may be modified during a transformation process or a post-transformation process and are respective to the type of organization being multiplied. The baseline variance may be an historical baseline (utilized to obtain an historical average), an organizational baseline and/or a regional baseline. The baseline variance numerically changes as new organizational data and new sentiment data are obtained.

The financial index is derived from the organizational data and the sentiment data during a fixed period of time. A new financial tradable index is computed as new sentiment and new organizational data is gathered. The financial tradable index comprises a variance valuation and is representative of social, economic, environmental, political, regulatory, legal, policy, technological and/or financial information. The financial tradable index provides price transparency in trading of an investment instrument through an exchange system and facilitates marketing, valuation, settlement, profit incentivizing, business hedging and index benchmarking of an investment instrument.

Additionally, the financial tradable index comprises at least one index value that is the basis for a transaction between two parties. The transaction comprises optionally entering the transaction and/or buying an index value. The transaction takes place on a financial exchange and/or separate from a financial exchange. Further, the financial tradable index is searchable via evaluating queries, wherein an algorithm assigns a search value to the evaluating queries comprising tagged search terms, phrases and/or individual words.

Further, the present invention is a method for generating a financial index comprising populating a computer server with organizational data, populating the computer server with sentiment data, applying a weighting value to the organizational and/or the sentiment data, calculating an index value, calculating a baseline value for the index value and disseminating the index value. The method further comprises converting the baseline value to an equivalent currency value. The organizational data comprises, without limitation, social, legal, environmental, political, policy, regulatory, technological, economic and financial information, while the sentiment data comprises, without limitation, results of surveys, questionnaires and/or ballots.

Further, the present invention is a method for generating a computer-processed financial tradable index comprising the steps of gathering organizational data, gathering sentiment data, tagging components of the sentiment data and the organizational data, combining the tagged organizational data and the tagged sentiment data, and computing a financial tradable index from the tagged data, wherein tagging the sentiment data and the organizational data comprises weighting words, descriptions, questionnaires and/or surveys in a computer system. The tagging process, in one embodiment assigns a numerical value to a word or phrase and further aggregates the words or phrases into a composite numerical value for the purposes of a tradable index value. In this embodiment, the computer generated numerical values are dependent on the sentiment process, that is, the results of votes, surveys or questionnaires or other data.

More specifically, the present invention is a method for generating a computer-processed financial tradable index, wherein public data, entity data and third party data are accessed. The public data, for exemplary purposes only, is accessed from municipalities, governments, not-for-profit organizations, multi-location organizations, multi-industry organizations and/or for-profit organizations. The entity data, for exemplary purposes only, is accessed from entities operating in a first geographic area, a second geographic area, a first industry, and/or a second industry. It will be recognized by those skilled in the art that data from entities located in more than two geographic areas and/or entities doing business in more than two industries could be utilized.

Subsequently, organizational data comprising public data, entity data and third party data is gathered from regulatory data, environmental data, economic data, technical data, social data, legal data, financial data, political data and/or policy data sources. The organizational data is then selected from independent parties, public domain sources, indexes and/or data representing indexes. It will be recognized by those skilled in the art that other sources of similar data could selectively be utilized.

Subsequently, weighting factors are quantified and the organizational data and the weighting factors are multiplied together, thereby creating, for exemplary purposes only, numerical baseline variances that coordinate to the type of the organizational data. The baseline variances are numerically indexed and may increase or decrease numerically and comprise an historical baseline, an entity baseline and a regional baseline. In at least one alternate embodiment, measurement of the organizational data may be ranked, rated or valued based on an approach beyond exclusive to financial analysis. Once data is populated into a computer server, whether sentiment or other, data can be measured relative to industry peers, organizations within a geographical area, others within a population, market capitalization, or size grouping. The computer process can dynamically rank position, score or aggregate composite data based on real-time or newly populated data. I.e., without limitation, if company X is a sector leader on a given date, new sentiment data and/or other data is populated into the computer system thereby updating/reducing company X to a third-ranked position based on the newest data input(s). Company X will have a numerical valuation within that index construction to be ranked. Company X may also be included in other indexes, including but not limited to geographical area-based.

Data from online communities is gathered via, for exemplary purposes only, technology networks and/or Internet websites. Group data is requested and comprises, for exemplary purposes only, the results of perception polls, surveys, questionnaires, pick lists, votes, opinion polls and/or individual opinions. Sentiment data, comprising the data from online communities and the group data, is gathered, wherein the sentiment data is subsequently optionally multiplied by weighting factors, thereby creating, for exemplary purposes only, numerical baseline variances that coordinate to the type of the sentiment data gathered. The numerical baseline variances are numerically indexed and may increase or decrease numerically.

It is particularly noted that the organizational data may be selectively modified or not modified, and information received as organizational data may or may not be modified, or may be modified by different weighting factors for each data source. Similarly, the sentiment data selectively may or may not be modified by the weighting factors or source information may be modified by different weighting factors.

The sentiment data and the organizational data are selectively tagged, thereby creating tagged sentiment data and tagged organizational data. The tagged organizational data and the tagged sentiment data are then converted into value data that is aggregated to form the index.

Subsequently, the organizational data and the sentiment data are combined and an index is computed. The index is selectively independently traded and/or the index is utilized to modify investments, such as, for exemplary purposes only, stocks, bonds, or the like. The modified investment could subsequently be traded, thereby creating for exemplary purposes only, an exchange system or the like. To trade the index, the modified index is valued, marketed and settled. Once the index is valued it may further be benchmarked. Additionally, to financially market the index, a fair valuation is determined. Fair value may include last numerical level that traded, either independently, or as a component within composite, or a reasonable indication or estimation of where it might trade. Once marketed, financial valuation of profit or loss can be determined. In at least one embodiment, the index is a content-weighted financial market index measuring content, including historical baseline content, against recent actions of organizations.

The obtained organizational data comprising the public data, the entity data and the third party data is stored in a server. The server comprises a database, storage fields, an input generator, an output generator and a choice generator, all in electrical communication with the server. The server is in data communication with a computer and the computer computes the index. Similarly, the sentiment data comprising the community data and the group data that have been obtained by query and response are stored in the server. The server is in data communication with the computer and the computer computes the index.

In one alternate embodiment, the method for generating a computer-processed financial tradable index comprises a method for receiving a bid order for an index value, matching the bid order with such index value and transferring ownership of the corresponding index to the bidder. In another embodiment, an indicator could be utilized that places a value on the natural Earth in its current, worsened or improved state. The indicator may be a measurement of the value of human potential, the contribution of an entity to the value of the natural Earth or human potential or the relative contribution of an entity to the value of the natural Earth.

For example, the indicator comprises an index that is a benchmark for total and unified sustainability of entities, such as, for exemplary purposes only, corporations, governments, regions, and individuals, wherein political, economic, social, technological, legal and environmental data are combined into a single index. The single index comprises an indicator of progress toward three objectives, namely, climate balance, restoring Earth and uplifting humanity. The single index is utilized to re-price investment capital and portfolios, inform public policy and create a new Earth-resource based currency, wherein the single index is designed to incentivize support of the objectives, and wherein achievement of the objectives results in increased global happiness on a massive scale.

The single index is administered by a wiki-based community, wherein the wiki-based community engages in collaborative production against a set of well-defined measurement methods and types of data sets, augmented by the dynamic data and opinion updates of community. Subject matter experts administer surveys to judge competency and voting currency, wherein such are administered accordingly. Responses to relevant sentiment questions are developed for voting participant at all levels and the results are calibrated into the larger equation. As the wiki-based community expands by enfranchisement into the system by more populations, the index gains increased traction and credibility.

Accordingly, a feature and advantage of the present invention is its ability to forecast the social, environmental, political, economic, technological and legal behavior of local, regional and global organizations by disseminating a financial index.

Another feature and advantage of the present invention is its ability to improve the global environment and uplift humanity.

Still another feature and advantage of the present invention is its ability to facilitate climate balance.

Yet another feature and advantage of the present invention is its ability to evaluate companies beyond financial measures by taking into account sentiment data and other variables.

Yet still another feature and advantage of the present invention is its ability to evaluate corporate actions regarding natural resources and the environment.

A further feature and advantage of the present invention is its ability to provide transparent numerical values used to rate companies within a defined sector.

Yet still another feature and advantage of the present invention is its ability to encourage socially responsible practices.

A further feature and advantage of the present invention is its ability to accommodate a wide variety of digital information.

Another feature and advantage of the present invention is its ability to take into consideration and factor in human-based data from on-line communities.

Yet still another feature and advantage of the present invention is its ability to provide company transparency, goal setting, forecasting and policy making.

Yet still a further feature and advantage of the present invention is its ability to easily disseminate financial indices and ranking of corporate entities.

Yet another feature and advantage of the present invention is its ability to classify data based on region, size or sector.

Still another feature and advantage of the present invention is its ability to provide a useful process of data aggregation to provide transparency for the purpose of potential investment, credit rating, sustainable practice rating, corporate policy, scorecard valuation and financial trading.

Yet still another feature and advantage of the present invention is its ability to classify sentiment data related to the environment, politics, economy, technology, law and finance by surveying an on-line community.

Yet another feature and advantage of the present invention is its ability to provide benchmarks for evaluating the results of enlightened self-interest.

One further feature and advantage of the present invention is that the theoretical underpinning is organized around the search for a dynamic equilibrium, wherein there is a balance within the equilibrium of constant change of social, economic, environmental factors, and the like.

Yet another feature and advantage of the present invention is that future sustainability goals may be defined as “potential” for reaching balance over time through change.

These and other features and advantages of the present invention will become more apparent to one skilled in the art from the following description and claims when read in light of the accompanying drawings.

### BRIEF DESCRIPTION OF THE SEVERAL VIEWS OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a flowchart illustrating a preferred embodiment of a method for generating a computer-processed financial tradable index;

FIG. 2 is a detail flowchart of obtaining public data according to a preferred embodiment of a method for generating a computer-processed financial tradable index;

FIG. 3 is a detail flowchart of selecting organizational data according to a preferred embodiment of a method for generating a computer-processed financial tradable index;

FIG. 4 is a detail flowchart of obtaining group data according to a preferred embodiment of a method for generating a computer-processed financial tradable index;

FIG. 5 is a detail flowchart of the flow of organizational data between a server and a computer according to a preferred embodiment of a method for generating a computer-processed financial tradable index;

FIG. 6 is a detail flowchart of accessing entity data according to a preferred embodiment of a method for generating a computer-processed financial tradable index;

FIG. 7 is a detail flowchart of the flow of sentiment data between a server and a computer according to a preferred embodiment of a method for generating a computer-processed financial tradable index;

FIG. 8 is a detail flowchart of quantifying weighting factors and calculating a baseline variance according to a preferred embodiment of a method for generating a computer-processed financial tradable index;

FIG. 9 is a detail flowchart of the steps in trading an index and trading a modified index according to a preferred embodiment of a method for generating a computer-processed financial tradable index;

FIG. 10 is a detail flowchart of gathering organizational data according to a preferred embodiment of a method for generating a computer-processed financial tradable index;

FIG. 11 illustrates the components of a server according to a preferred embodiment of a method for generating a computer-processed financial tradable index;

FIG. 12 is a detail flowchart of tagging organizational data and sentiment data according to a preferred embodiment of a method for generating a computer-processed financial tradable index;

FIG. 13 is a detail flowchart of gathering surveys and votes according to a preferred embodiment of a method for generating a computer-processed financial tradable index;

FIG. 14 is a detail flowchart of a index utilized as a benchmark for total and unified sustainability of entities according to a preferred embodiment of a method for generating a computer-processed financial tradable index; and

FIG. 15 is a detail flowchart of a index administered by wiki-based community according to a preferred embodiment of a method for generating a computer-processed financial tradable index.

### DETAILED DESCRIPTION OF THE PREFERRED AND SELECTED ALTERNATE EMBODIMENTS OF THE INVENTION

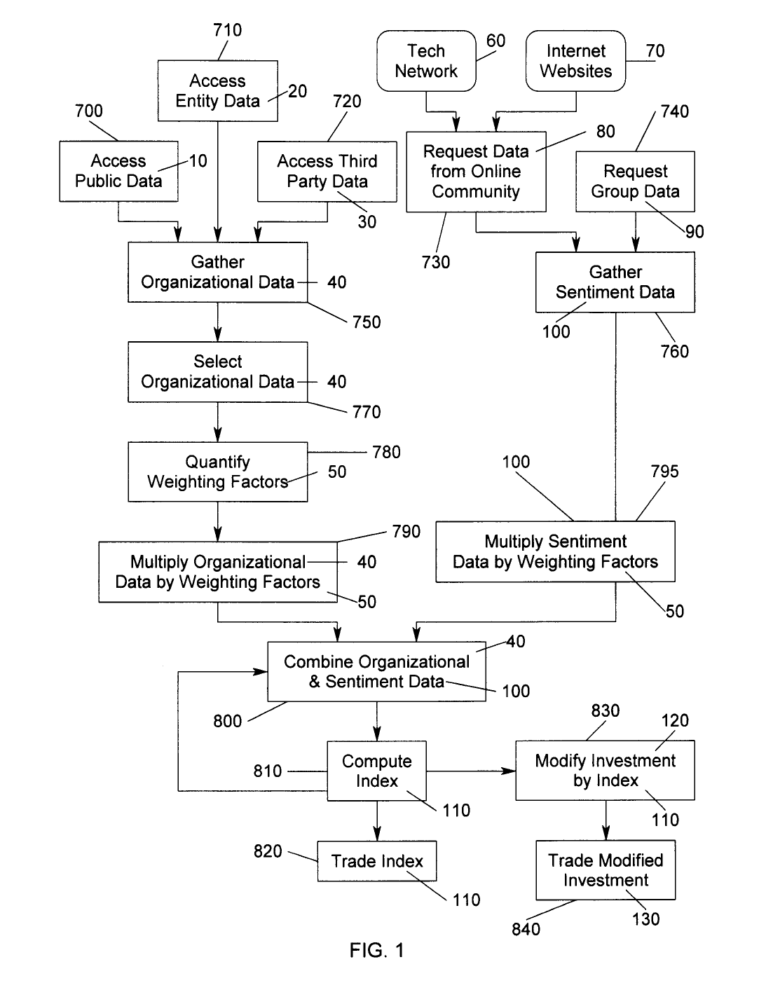

In describing the preferred and selected alternate embodiments of the present invention, as illustrated in FIGS. 1-15, specific terminology is employed for the sake of clarity. The invention, however, is not intended to be limited to the specific terminology so selected, and it is to be understood that each specific element includes all technical equivalents that operate in a similar manner to accomplish similar functions.

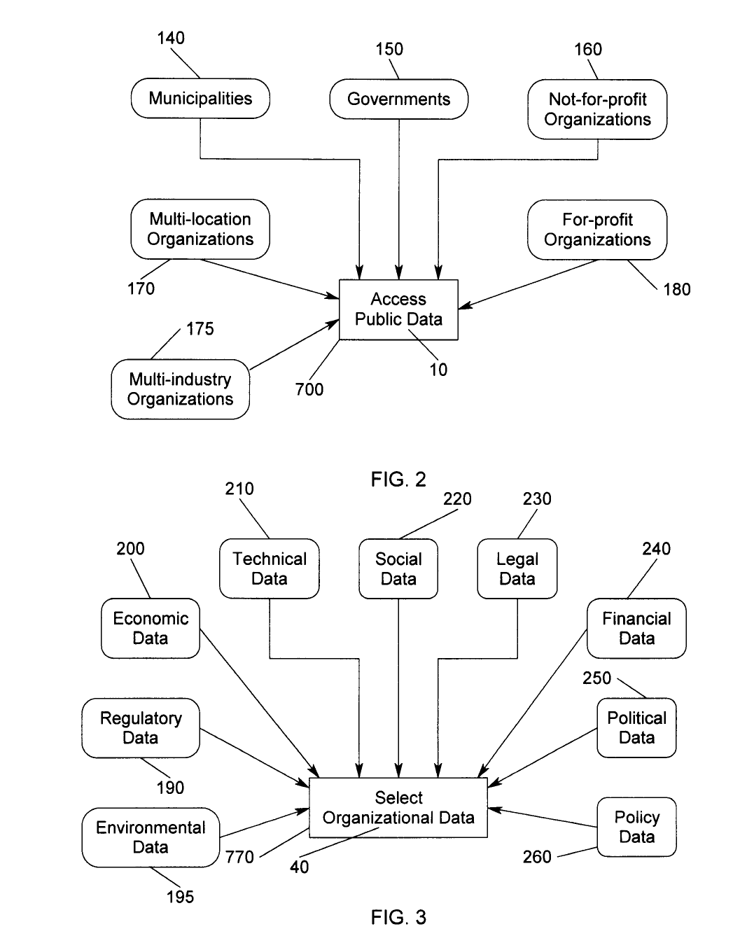

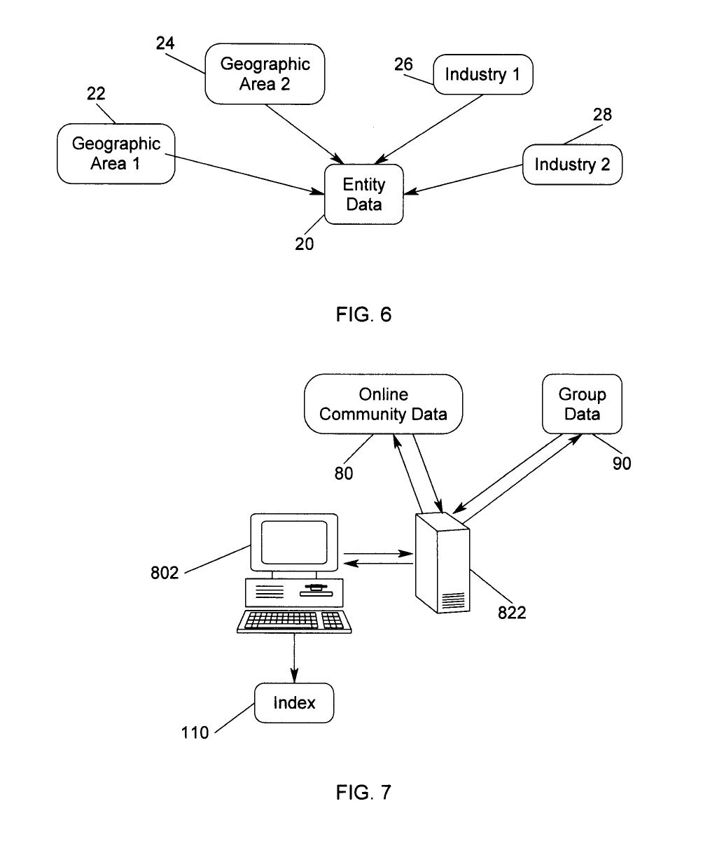

Referring now to FIGS. 1-15, in the method for generating a computer-processed financial tradable index, public data 10 is accessed via step 700, entity data 20 is accessed via step 710 and third party data 30 is accessed via step 720, wherein public data 10, for exemplary purposes only, is accessed from municipalities 140, governments 150, not-for-profit organizations 160, multi-location organizations 170, multi-industry organizations 175, and/or for-profit organizations 180 (best shown in FIG. 2), and wherein entity data 20, for exemplary purposes only, is accessed from entities in first geographic area 22, second geographic area 24, first industry 26, and/or second industry 28 (best shown in FIG. 6). It will be recognized by those skilled in the art that entities located in more than two geographic areas and/or entities doing business in more than two industries could be utilized. It will further be recognized by those skilled in the art, that organizational data 40 could be obtained from publications or accessed via a network, including the Internet.

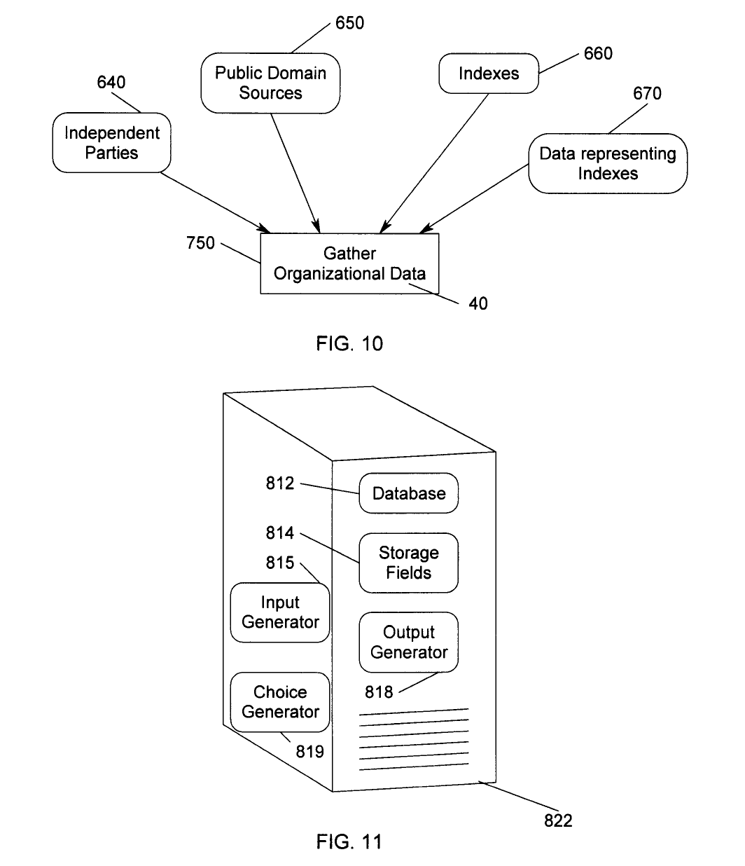

Subsequently, organizational data 40, comprising public data 10, entity data 20 and third party data 30, is gathered via step 750. Organizational data 40 is selected via step 770, wherein organizational data 40 is selected from regulatory data 190, environmental data 195, economic data 200, technical data 210, social data 220, legal data 230, financial data 240, political data 250 and/or policy data 260 (best shown in FIG. 3), and wherein organizational data 40 is gathered via step 750 from independent parties 640, public domain sources 650, indexes 660 and/or data representing indexes 670 (best shown in FIG. 10). It will be recognized by those skilled in the art that other sources of data could selectively be utilized.

Weighting factors 50 correspond to respective organizational data 40 and are quantified via step 780. Organizational data 40 and weighting factors 50 are subsequently multiplied together via step 790, thereby creating, for exemplary purposes only, numerical baseline variances 55 that coordinate to the type of organizational data 40, wherein baseline variances 55 are numerically indexed, and wherein baseline variances 55 may increase or decrease numerically.

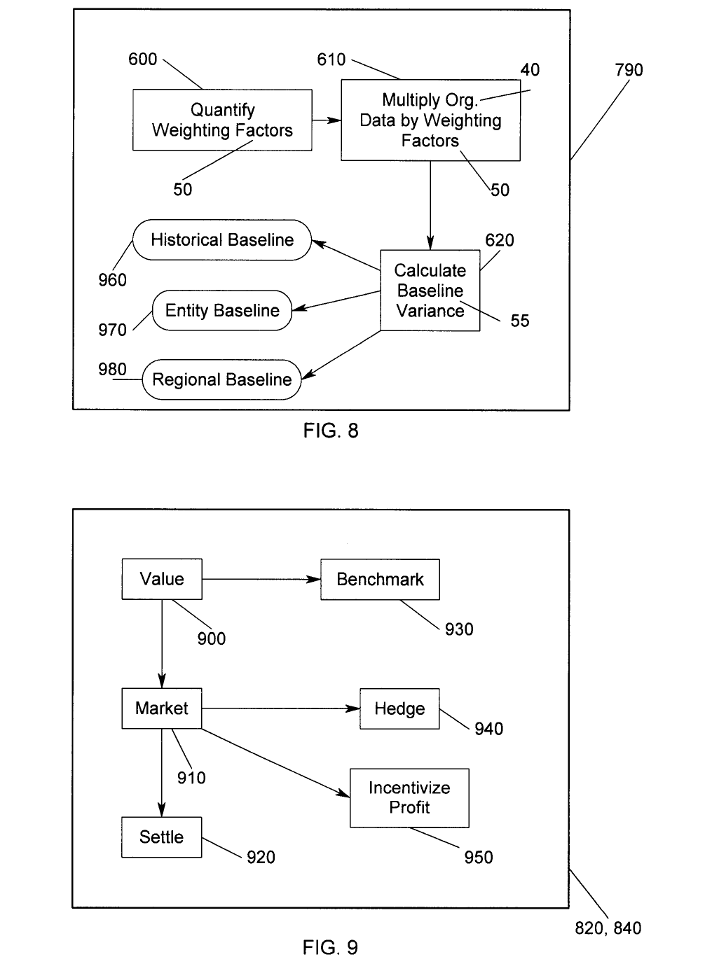

Referring now more specifically to FIG. 8, step 790 further comprises quantifying weighting factors 50 via step 600, multiplying organizational data 40 by weighting factors 50 via step 610 and calculating baseline variance 55 via step 620, wherein baseline variance 55 comprises historical baseline 960, entity baseline 970 and regional baseline 980. In at least one alternate embodiment, measurement of organizational data 40 may be ranked, rated or valued based on an approach beyond exclusive to financial analysis.

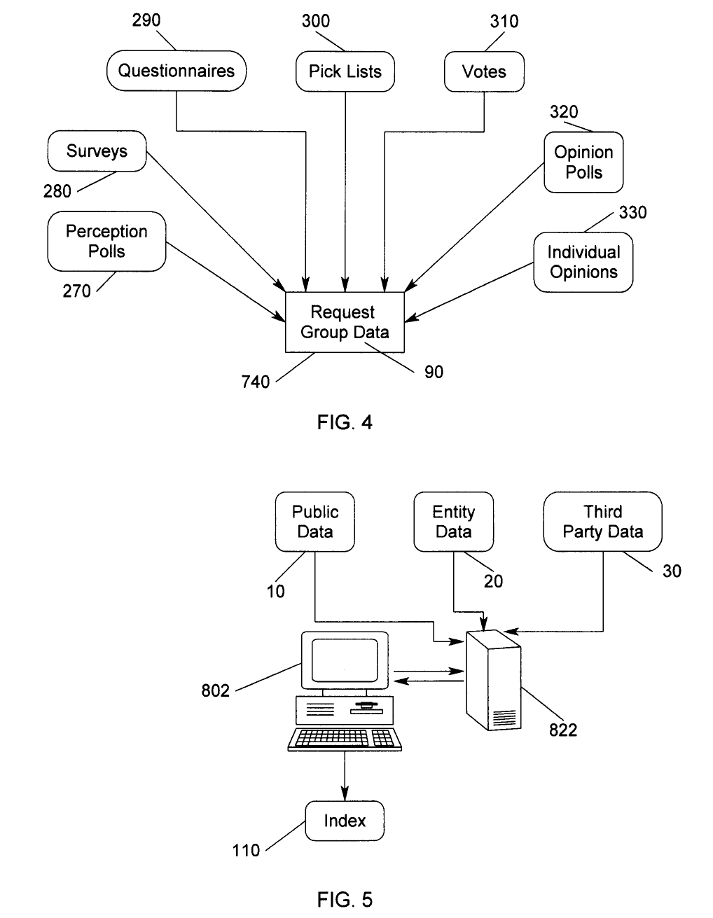

Returning again to FIG. 1, sentiment data 100 comprising online community data 80 is requested via step 730, wherein online community data 80 comprises, for exemplary purposes only, technology network 60 and/or Internet websites 70. Additionally, group data 90 is obtained via step 740, wherein group data 90 comprises, for exemplary purposes only, the results of perception polls 270, surveys 280, questionnaires 290, pick lists 300, votes 310, opinion polls 320 and/or individual opinions 330 (best shown in FIG. 4), wherein surveys 280 and votes 310 are managed by subject matter experts 1130 (best shown in FIG. 13). Sentiment data 100, comprising online community data 80 and group data 90, is gathered via step 760. Sentiment data 100 and weighting factors 50 are subsequently multiplied together via step 795, thereby creating, for exemplary purposes only, numerical baseline variances 55 that coordinate to the type of sentiment data 100, wherein baseline variances 55 are numerically indexed, and wherein baseline variances 55 may increase or decrease numerically. It will further be recognized by those skilled in the art, that sentiment data 100 could be obtained from publications or accessed via a network, including the Internet.

It is particularly noted that organizational data 40 may selectively be modified or not modified, and information received as organizational data 40 may or may not be modified, or may be modified by different weighting factors 50 for each data source. Similarly, sentiment data 100 selectively may or may not be modified by weighting factors 50 or source information may be modified by different weighting factors 50.

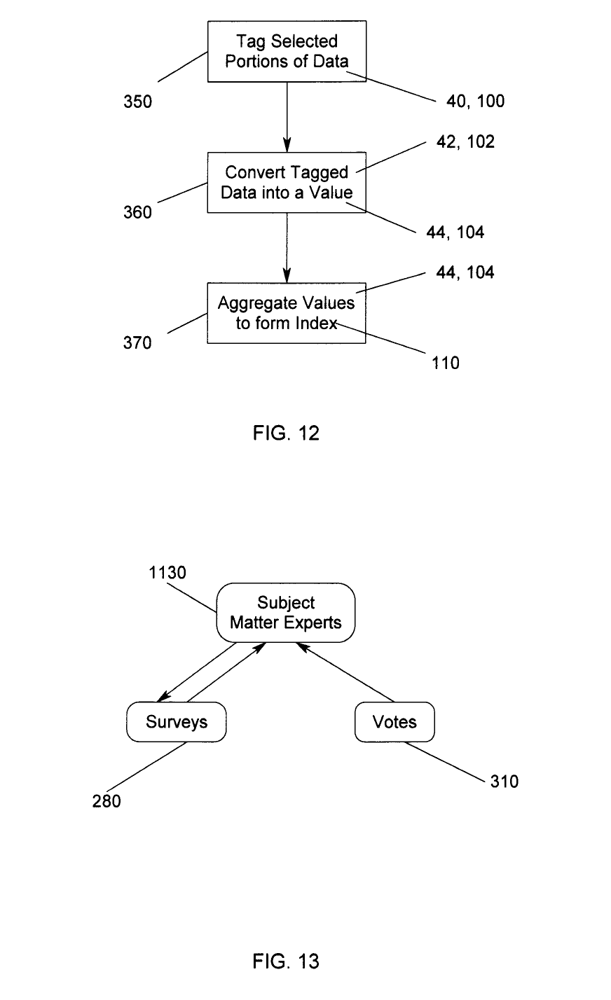

Referring now to FIG. 12, sentiment data 100 and organizational data 40 are selectively tagged via step 350, thereby creating tagged sentiment data 102 and tagged organizational data 42. Tagged organizational data 42 and tagged sentiment data 102 are next converted into value data 44, 104, respectively, via step 360, wherein value data 44, 104 are subsequently aggregated to form index 110 via step 370.

Returning again to FIG. 1, following steps 760 and 790, organizational data 40 and sentiment data 100 are combined via step 800, wherein index 110 is subsequently computed via step 810. Index 110 is selectively independently traded via step 820. Index 110 could also be utilized to modify investment 120 via step 830, wherein investment 120 comprises, for exemplary purposes only, stocks, bonds, or the like. Modified investment 130 could subsequently be traded via step 840, thereby creating for exemplary purposes only, an exchange system or the like.

Turning now to FIG. 9, steps 820 and 840 further comprise valuing step 900, marketing step 910 and settling step 920, wherein valuing step 900 further comprises benchmarking step 930. Selectively, marketing step 910 could comprise hedging step 940 and incentive profiting step 950. In at least one embodiment, index 110 is a content-weighted financial market index measuring content, including historical baseline content, against recent actions of organizations.

Referring now to FIGS. 5 and 11, obtained organizational data 40 comprising public data 10, entity data 20 and third party data 30 is stored in server 822, wherein server comprises database 812, storage fields 814, input generator 815, output generator 817 and choice generator 819, all in electrical communication with server 822. Server 822 is in communication with computer 802, wherein computer 802 computes index 110. Similarly, as shown in FIG. 7, sentiment data 100 comprising community data 80 and group data 90 that have been obtained by query and response are stored in server 822, wherein server 822 is in communication with computer 802, and wherein computer 802 computes index 110.

In an alternate embodiment, the method for generating a computer-processed financial tradable index could comprise a method for receiving a bid order for an index value, matching the bid order with such index value and transferring ownership of the corresponding index to the bidder.

In yet another embodiment, an indicator could be utilized that places a value on the natural Earth in its current, worsened or improved state. The indicator may be a measurement of the value of human potential, the contribution of an entity to the value of the natural Earth or human potential or the relative contribution of an entity to the value of the natural Earth.

In still another alternate embodiment, the financial tradable index is computed as representative of variance valuation, wherein variance represents the difference between either a previous value or baseline, the resulting index value is based on the change or variance from a current value against a baseline or against a previous value. I.e., if the Dow Jones Industrial Average was 11,500 yesterday and 11,000 today the “variance valuation” is −500 (negative); alternatively, if the baseline is 10,000, the “variance valuation” is +1,000 (positive).

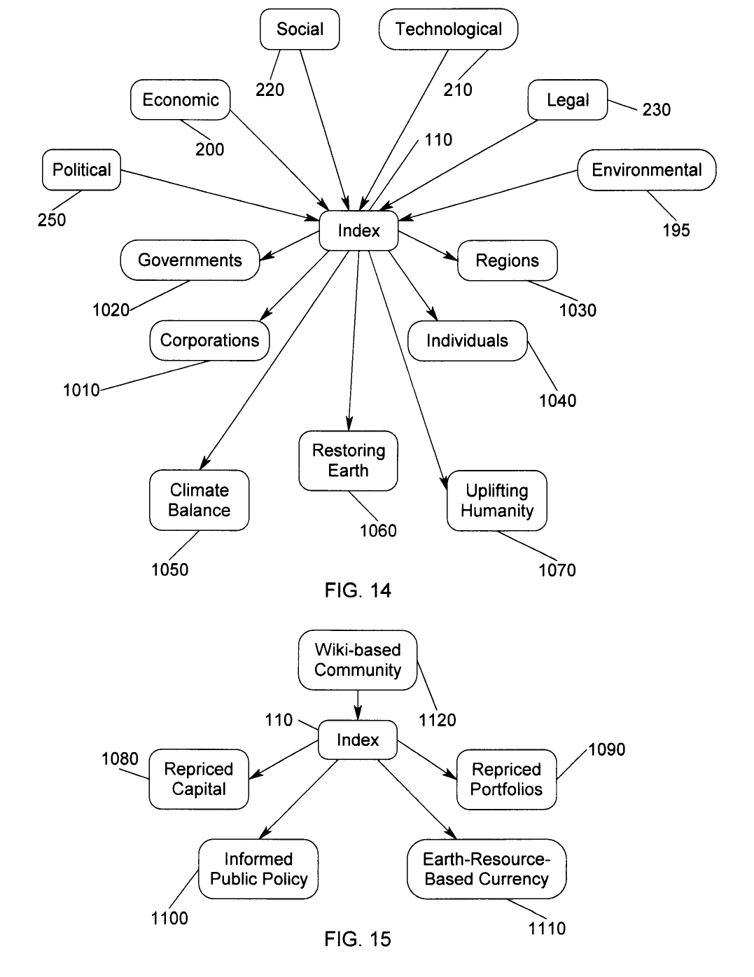

Turing to FIGS. 14 and 15, for example, index 110 comprises a benchmark for total and unified sustainability of entities, such as, for exemplary purposes only, corporations 1010, governments 1020, regions 1030, and individuals 1040, wherein political 250, economic 200, social 220, technological 210, legal 230 and environmental 195 are combined into single index 110. Single index 110 comprises an indicator of progress toward three objectives, namely, climate balance 1050, restoring Earth 1060 and uplifting humanity 1070. Single index 110 is utilized to create re-priced investment capital 1080 and portfolios 1090, inform public policy 1100 and create a new Earth-resource based currency 1110, wherein single index 110 is designed to incentivize support of objectives 1050, 1060, 1070, and wherein achievement of objectives 1050, 1060, 1070 results in increased global happiness on a massive scale.

Single index 110 is administered by wiki-based community 1120, wherein wiki-based community 1120 engages in collaborative production against a set of well-defined measurement methods and types of data sets, augmented by the dynamic data and opinion updates of community 1120. Subject matter experts 1130 administer surveys 280 (best shown in FIG. 13) to judge competency and voting currency wherein such are administered accordingly. Responses to relevant sentiment questions are developed for voting participant at all levels and the results are calibrated into the larger equation. As the wiki-based community 1120 expands by enfranchisement into the system by more populations, index 110 gains increased traction and credibility.

The technical requirements of the index comprise two categories, data and mathematical:

### 1. Data.

a. capturing pre-populated raw data sets of PESTLE information 250, 200, 220, 210, 230, 195 (other data will be contributed via surveys 280 or third parties 30).

b. capturing pre-populated sentiment data 100 regarding PESTLE 250, 200, 220, 210, 230, 195 activity (other data will be contributed via votes 310).

c. data warehouse and retrieval strategies for all types of data sets (captured or contributed).

d. automating capture and retrieval to the highest degree possible.

e. employment of text analytics to analyze non-voted sentiment data sets (from blogs, articles, postings, etc.) and derive meaningful sentiment results.

f. employment of text analytics to categorize raw PESTLE data 250, 200, 220, 210, 230, 195 into meaningful measurements.

g. processing all captured and contributed raw/sentiment data into a mathematical formula on an automatic, dynamic basis.

### 2. Mathematics.

a. creating a voting currency, namely by solving the “completeness” problem of giving enough votes to create a univocal relationship between questions and expressed preferences/predictions and at the same time giving the currency value by making it relatively scarce.

b. creating the index formula or algorithm that collects the results of captured and contributed raw/sentiment data and combines into a single number.

c. identifying whether or not an intuitive/spiritual constant such as Phi (1.1618 . . . ) also known as the golden mean/golden ratio or represented as Fibonacci sequence belongs in the index equation as a basis for measurement, goal/result target, indicator of performance, etc., and providing a logical rationale as to why this would be true.
i. the Fibonacci sequence/phi logarithm is the path of least resistance for self-replication within an open system; there is further a rationale for tying this sequence to performance against three objective 1050, 1060, 1070 derived goals.
ii. the golden mean/ratio is a natural phenomenon based on natural and cosmic mathematics; thus, there is a rationale for setting goals in harmony with this ratio.
iii. other mathematical constants similar to Phi could exist that achieve these same ends.
iv. combining goal setting of (ii) and working backwards to achieve benchmarks set by (i) facilitate rapid achievement of three objectives 1050, 1060, 1070.

d. identifying relative vs. absolute measurement problems and solving for those with different approaches.

e. identifying an approach to tie the directional movement toward the three objectives 1050, 1060, 1070 to the rising of happiness on a global scale.

The foregoing description and drawings comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the present invention is not limited to the specific embodiments illustrated herein, but is limited only by the following claims.

What is claimed is:

1. A method for generating a computer-processed financial tradable index, said method comprising the steps of:
gathering organizational data;
gathering sentiment data;
combining said sentiment data with said organizational data; and
computing said financial tradable index.

2. The method of claim 1, wherein said step of gathering said organizational data further comprises the step of:
obtaining said organizational data from the group consisting of public databases, entity databases, third-party databases, and combinations thereof.

3. The method of claim 1, wherein said organizational data is objective.

4. The method of claim 1, wherein said sentiment data is subjective.

5. The method of claim 1, wherein said step of gathering said sentiment data further comprises the step of:
gathering said sentiment data from a plurality of users in an on-line community.

6. The method of claim 5, wherein said sentiment data comprises consensus data.

7. The method of claim 5, wherein said on-line community includes technology networks and Internet websites.

8. The method of claim 1, wherein said step of gathering said sentiment data further comprises the step of:
selecting said sentiment data from the group consisting of responses to surveys, questionnaires, on-line pick lists, votes, opinion polls, perception polls, individual opinions, and combinations thereof.

9. The method of claim 1, said method further comprising the step of:
obtaining said organizational data from sources selected from the group consisting of social information, legal information, technological information, economic information, financial information, political information, regulatory information, environmental information, policy information, and combinations thereof.

10. The method of claim 1, said method further comprising the step of:
obtaining said organizational data from sources selected from the group consisting of municipalities, governments, for-profit entities, non-profit entities, organizations that operate in a plurality of geographic locations, organizations that operate in a plurality of industries, and combinations thereof.

11. The method of claim 1, said method further comprising the step of:
providing price transparency in trading of an investment instrument through an exchange system.

12. The method of claim 11, wherein said step of facilitating trading in an investment instrument comprises the step of:
facilitating marketing, valuation, settlement, profit incentive, business hedging and index benchmarking of an investment instrument.

13. The method of claim 1, said method further comprising the steps of:
obtaining said organizational data, wherein said organizational data is directly delivered; and
aggregating said organizational data into a computer server.

14. The method of claim 13, said method further comprising the steps of:
applying a weighting method to said organizational data, thereby forming weighted organizational data; and
forming an index from said weighted organizational data.

15. The method of claim 1, said method further comprising the steps of:
obtaining said organizational data from third parties; and
aggregating said organizational data into a computer server.

16. The method of claim 1, said method further comprising the step of:
multiplying said organizational data by weighting factors, wherein a baseline variance is created.

17. The method of claim 16, wherein said baseline variance is an historical baseline.

18. The method of claim 16, wherein said baseline variance is an organizational baseline.

19. The method of claim 16, wherein said baseline variance is a regional baseline.

20. The method of claim 16, wherein said baseline variance numerically changes as new organizational data and new sentiment data is obtained.

21. The method of claim 16, wherein said baseline variance is utilized to obtain an historical average.

22. The method of claim 16, wherein said weighting factors are respective to the type of organizational data being multiplied.

23. The method of claim 16, said method further comprising the step of:
quantifying said respective weighting factors.

24. The method of claim 1, wherein said step of combining said sentiment data with said organizational data further comprises the step of:
accumulating said sentiment data and said organizational data into a computer server.

25. The method of claim 1, wherein said organizational data and said sentiment data are based on a plurality of measurement and weighting conventions.

26. The method of claim 1, said method further comprising the step of:
obtaining said organizational data from entities existing in a plurality of geographic locations.

27. The method of claim 1, said method further comprising the step of:
obtaining said organizational data from entities operating in a plurality of industries.

28. The method of claim 1, wherein said organizational data is characterized by positive and negative numerical changes.

29. The method of claim 1, said method further comprising the step of:
relating said organizational data to financial, legal, environmental, economic, political, social, regulatory, policy and technological information.

30. The method of claim 1, wherein said organizational data comprises at least one data input selected from the group consisting of policy, environment, technology, economic, financial, legal, political, regulatory, social information, and combinations thereof.

31. The method of claim 1, wherein said step of gathering said sentiment data further comprises the step of:
obtaining a communications network, wherein said communications network comprises at least one terminal having an input device and at least one server, wherein said at least one server comprises at least one database, and wherein said at least one database comprises storage fields, an input data object generator, an output data object generator and a choice generator.

32. The method of claim 1, wherein said step of gathering said organizational data further comprises the step of:
obtaining said organizational data from sources selected from the group consisting of independent parties, public domain sources, indexes, data representing said indexes, and combinations and thereof.

33. The method of claim 1, wherein said step of gathering said sentiment data further comprises the step of:
obtaining said sentiment data from technology networks and internet websites.

34. The method of claim 1, wherein said financial tradable index is representative of social, economic, environmental, political, regulatory, legal, policy, technological and financial information.

35. The method of claim 1, wherein said step of computing said financial tradable index is representative of variance valuation.

36. The method of claim 1, wherein said financial tradable index further comprises at least one index value, and wherein said at least one index value is the basis for a transaction between at least two parties.

37. The method of claim 36, wherein said transaction takes place on a financial exchange.

38. The method of claim 36, wherein said transaction takes separate from a financial exchange.

39. The method of claim 1, wherein said step of computing said financial tradable index further comprises the step of:
recompiling a new financial tradable index when new sentiment and new organizational data is gathered.

40. The method of claim 1, wherein said step of computing said financial tradable index further comprises the step of:
deriving said financial tradable index during a fixed period of time.

41. The method of claim 1, wherein said step of computing said financial tradable index further comprises the step of:
recompiling a new financial tradable index when additional sentiment data and additional organizational data are gathered.

42. The method of claim 1, wherein said step of gathering sentiment data further comprises the step of:
obtaining said sentiment data from a voting community via a computer network.

43. The method of claim 1, wherein said step of combing said sentiment data with said organizational data further comprises the step of:
processing said sentiment data and said organizational data via a computer network; and
attaching numerical values to words or phrases for the purpose of index creation or valuation.

44. The method of claim 1, wherein said sentiment data and said organizational data is gathered from a plurality of data sources.

45. The method of claim 1, wherein said method further comprises the step of:
searching said financial tradable index via evaluating queries, wherein said evaluating queries comprise search terms, phrases and individual words.

46. The method of claim 45, wherein said evaluating queries are assigned a search value via a search value algorithm.

47. A method of generating a financial index comprising the steps of:
populating a computer server with organizational data, wherein said organizational data is selected from the group consisting of social, legal, environmental, political, policy, regulatory, technological, economic and financial information, and combinations thereof;
populating said computer server with sentiment data selected from the group consisting of results of surveys, questionnaires, ballots, and combinations thereof;
applying a weighting value to said organizational and sentiment data;
calculating an index value;
calculating a baseline value for said index; and
disseminating said index value.

48. The method of claim 47, wherein said step of calculating a baseline value further comprises the step of:
converting said baseline value to an equivalent currency value.

49. A method for generating a computer-processed financial tradable index, said method comprising the steps of:
gathering organizational data;
gathering sentiment data;
tagging said sentiment data and said organizational data into a numerical valuation;
combining said organizational data and said sentiment data; and
computing a financial tradable index.

50. The method of claim 49, wherein said step of tagging said organizational data and said sentiment data further comprises the step of:
weighting words, descriptions, questionnaires, surveys, and combinations thereof in a computer system.
